(19) United States
(12) Patent Application Publication
(10) Pub. No.: US 2008/0116722 A1
(43) Pub. Date: May 22, 2008

(54) Support Module for Vehicle Doors and Method of Mounting Same

(75) Inventors: Jose Francisco Garcia Martin, Burgos (ES); David Osorio Ortega, Burgos (ES); Cesar Marcos Gonzalez, Burgos (ES)

Correspondence Address: BANNER & WITCOFF, LTD., 1100 13th STREET, N.W., SUITE 1200, WASHINGTON, DC, 20005-4051, US

(73) Assignee: Grupo Antolin-Ingenieria, S.A., Burgos (ES)

(21) Appl. No.: 11/883,221

(22) PCT Filed: Sep. 30, 2005
(86) PCT No.: PCT/ES05/70136

§ 371 Date: Jul. 27, 2007

(30) Foreign Application Priority Data
Jan. 28, 2005 (EP) 05381002.4

(51) Int. Cl. B60J 5/04; B60R 27/00

(52) U.S. Cl. 296/208; 296/146.7; 49/502

(57) ABSTRACT

The present invention relates to a supporting module for vehicle doors and a mounting procedure for said module, wherein said module incorporates the usual functional elements provided in vehicle doors and is meant to facilitate the mounting tasks. It incorporates an element meant to provide a sealing by covering one of the main openings of the inner plate of the door box, thereby separating the wet area and the dry area of the vehicle. The special configuration of the module and the openings of the inner plate of the door box facilitate the mounting and removal tasks of the module and the elements incorporated on the door, as well as the establishment of a sealing. In addition, the module is freed of all structural responsibilities.

### OBJECT OF THE INVENTION

The present invention relates to a supporting module for vehicle doors and the mounting procedure for said module, in which said module incorporates the usual functional elements provided in motor vehicle doors in order to simplify the mounting tasks.

This module is characterised by the fact that the door trim itself acts as the supporting element.

The module is also characterised in that the trim does not provide the sealing function; instead, it incorporates at least one element meant to establish a sealing by covering one or some of the main openings of the inner plate of the door box.

The inner plate of the box has, in addition to the minor opening housing devices such as the speaker, at least one main opening needed to mount the supporting module and its components. This opening (or openings) is covered by one or several sealing elements.

It characterizes the fact that the sealing element has an individual attachment system, not external, for its attachment to the door box. Attaching this element permanently separates the wet and the dry area by a sealing.

The dry area has the same conditions as the vehicle interior and lies between the trim and the inner face of the inner plate of the door box, whose main openings are covered by the speaker, the plugs and mainly by the sealing element(s). The wet area corresponds to the box area between the outermost plates.

It characterizes a special configuration of the module adapted to the openings of the inner plate of the door box that facilitate the mounting and removal operations of the elements that the module incorporates on the door, as well as providing a sealing.

The module is characterised in that it is free of all structural responsibilities, which fall on the door itself.

This invention is characterised in that it allows to attach the sealing element to the door box space in different attachment relationships with the trim.

Also pertaining to the invention is the procedure for mounting the module and its elements on the door, in which the main opening(s) of the door box plate that is (are) closed by the sealing element(s), together with the opening of the supporting module that houses the insert, allow the independent mounting and removal of each functional element of the door.

### BACKGROUND OF THE INVENTION

Supporting modules for vehicle doors incorporating several functional elements, such as a speaker, lock, window lift, etc. are known in the state of the art.

These supports may have merely supporting roles or may additionally have structural roles, reinforcing the door.

Supporting modules are employed placed in the door box which are then covered by the trim. Also known are supporting trim panels that require the use of panels to separate the dry and the wet area.

In any case, it is always necessary to ensure the seal between the dry and the wet area, for which several solutions are also known.

Worth mentioning are the following documents, cited as solutions to the above:

Patent WO03031233 relates to a trim door module that incorporates several functional elements (such as a speaker, door lock, etc.) to which is attached a flexible sheet that acts as a shield against water passage to provide a sealing. This flexible sheet is attached to the door module by an adhesive and is provided with a sealing gasket on all or part of the perimeter of the water shield. It also has a peripheral shape similar to that of the trim module.

U.S. Pat. No. 6,510,657 relates to a supporting module for vehicle doors that supports functional elements such as the window lift, speaker or lock. Said module is formed by two panels joined by a rigid structure, which are placed in the housing provided for such purpose on the inside of the door with a configuration similar to that of the modules, so that they fit in perfectly and are sealed to provide a waterproof union.

Another example is U.S. Pat. No. 6,767,049, which relates to a trim panel for vehicle doors to which a panel is attached that acts as a water shield preventing water to pass from the outside of the vehicle to its interior compartment, having a similar configuration to the panel. This waterproof shield is sealed to the trim by an adhesive union and is provided with several orifices, which are also surrounded by a sealing adhesive, which allow mounting the various functional elements typically incorporates in vehicle doors.

U.S. Pat. No. 5,904,002 relates to a structural supporting module for motor vehicle doors. It is a trim module that supports functional elements such as the lock, window lift, speaker and switches, but which requires an additional panel to provide a sealing. It is a sheet with a similar configuration to that of the supporting panel that is joined to it by an adhesive.

On another hand, the known solutions used to obtain a seal of the door are quite varied.

In other cases, the solution employed to obtain a seal consists of including a structural element attached to a large opening of the door. This element, generally known as a module carrier plate, is structural because the door opening is large, so that the door plate cannot fulfil a sufficiently large structural function to provide the required strength. Some examples of solutions similar to including a module carrier plate are described in patents D928685, U.S. Pat. No. 6,571,515 and U.S. Pat. No. 6,510,657.

Patent WO0176900 uses an injected element meant to cover a small opening in order to seal the door opening. This element is in turn a support for various door components, as it is exposed and includes components that are projected towards the interior of the vehicle. This element is not connected in any way to the trim; in addition, its location on the door does not allow integrating any function other than an armrest. The space it covers on the door does not allow to mount elements in the wet area such as window lift guides or to place the lock in it.

Although they provide a seal of the door, all of these solutions have several drawbacks. Solutions employing flexible sheets require the attachment of all the points of the perimeter, or alternatively the support of an element that is more rigid than the sheet, also requiring the plate on which they rest to be free of dust and grease to ensure its adherence.

In those inventions that use a module carrier plate this element, in addition to implying an additional piece, is a stiff element of large size, weight and cost. It also requires a large opening in the door, which weakens it so that the module carrier plate must provide the stiffening function. In addition, given its great weight and size it is cumbersome to handle.

The present invention describes a trim door module that incorporates several functional elements of the door and lacks any structural responsibilities.

The present invention facilitates the mounting and removal operations of the panel and the various functional elements incorporated, and ensures a sealing in a simple manner by incorporating a sealing element that is directly attached to the door housing.

### DESCRIPTION OF THE INVENTION

The present invention relates to a supporting trim module for vehicle doors and to the mounting procedure for said module and the elements it incorporates. The door trim is an element made of a flexible material, preferably plastic, which is not structural and incorporates several functional elements of the door.

In a conventional motor vehicle door two differentiates areas are normally defined: the dry area and the wet area, as indicated below.

The dry area is generally located between the face of the door box nearest the interior compartment and the door trim. This area has the same conditions as the interior compartment of the vehicle.

The wet area is located inside the door box, between the two outermost door plates. Water and dust enter this area, so that all components placed in this area must be suitably protected and able to withstand these conditions. In general, this implies an increased cost of these components.

In any case, it is necessary to have sealing means that separate the dry and wet areas of the door box adequately.

In the present invention, the trim panel mounts or pre-mounts (in the case that a component is mounted temporarily on the panel, or needs an additional operation for its final mounting) several functional components of the door, thereby performing the trim function as well as that of supporting element. To mount the components located in the wet area on the door, the inner plate of the door box is provided with at least one main opening; later, as will be described below, all main openings will be covered with a sealing element that establishes a sealing to separate the dry area from the wet area, ensuring the seal.

The inner plate of the door box may also be provided with another opening that is covered by the speaker, and other secondary orifices for mounting or regulating other components attached to the door. These orifices will also be covered or sealed later to ensure a full seal.

In this way, the separation between the dry and the wet area is established by the inner plate of the door box, and the sealing is achieved by a sealing element that covers the main opening of the plate, precisely the opening that provides access to the interior of the door box that constitutes the wet area. As stated above, there may be several main openings, in which case each one will be covered by a sealing element.

This sealing element, which in any case once installed will always be contained inside the door and concealed from view, is characterised by having own attachment means that allow a fast and simple attachment to the door box plate, as well as other attachment means, either temporary or permanent, to the trim. In addition, a very reliable sealing is achieved. The seal area is small compared to the total area of the door and as the door plate provides the stiffening function the rigidity is barely affected.

In the case of using temporary means of attachment of the sealing element to the trim panel, these may be of two types: one which establishes a connection to the trim when it fulfils its supporting function until the time of installation, and a second that maintains this temporary connection during the installation, so that in the second type two movements of the sealing element with respect to the panel are possible: a vertical movement and another movement perpendicular to the panel.

The sealing element and the trim panel can also be attached by permanent attachment means, i.e. attachment means that do not allow a relative movement between them, unlike the aforementioned temporary means. Therefore, the trim panel and the sealing element move jointly in their coupling to the door box plate.

In addition, as the trim panel does not have to provide the sealing, the assembly does not require the use of gaskets or other elements required to ensure the sealing.

Some of the advantages provided by the solution proposed by this invention, regardless of the mode of attachment of the trim to the sealing element, are the following:
The components do not have to be able to work in wet conditions, thereby reducing their cost of manufacture and increasing their reliability;
The mounting and removal operations of the components are performed in a traditional manner, without requiring changes in job positions or tools;
The seal established against the entry of dust, noise and water is identical to that obtained with a module carrier plate;
An improved performance in case of impact, flexion, door closing and loads exerted on the handle. The door box has orifices of small size, so that the structure is stronger and more resistant to impacts. This strength means that the flexion will be lower, the resistance of the assembly when closing the door will be greater and the load on the handle when closing the door will have an optimal performance;
The wire harness is established in the dry area and is connected and checked in said area, thereby reducing costs as it is not necessary to use special components that resist humidity. In addition, the mounting procedure does not require having to insert the hand through the plate orifice.

In the first case in which the connection between the trim and the sealing element is temporary until the time of installation, the following is also provided:
A simple mounting procedure, as since the sealing element and the trim are separated during the installation the worker does not have to handle the entire assembly performing complex motions to thread the lock, and may rest the trim next to the door holding only the sealing element, thereby simplifying the mounting operations;
Freedom to choose the mounting sequence of operations. The components may be pre-attached to the door plate to later attach them permanently to the door plate;
Freedom in the design of the door trim, as it is not necessary to define specific areas to provide access when mounting the internal components of the door;
Integration of functions; it is possible to integrate functions related to the rear part of the door: lock security, energy absorbing elements, panel attachments, water deflection elements, etc.

The trim panel also has a supporting nature and has several functional elements of the door incorporated, which can be:
1. Mounted permanently; these are components that belong to it, as they are mounted permanently on the panel. This is the case with the base of the pocket for containing objects (or the pocket front, according to each case) or the weather strip;
2. Pre-mounted; this means that they require a final mounting operation to attach them to the door in their working position. This is the case with the door handle, the speaker or the sealing element. However, the speaker may be bolted to the trim;
3. Temporarily mounted; this is, their union to the panel is temporary, and only meant to allow handling the assembly until their final mounting as their working position is in the door itself. This is the case with the window lift motor, rail, drum lid or external door opening actuator.

In any case, the trim panel also acts as a supporting element that facilitates the mounting operations of the various functional components of the door, reducing the number of operations required and the time of execution by simplifying the handling and transportation of the components until their final mounting on the door.

In addition, after all the components have been mounted on the door it is possible to remove each one independently without having to dismantle the entire assembly, such as when it is necessary to repair or replace any component.

Some of these components require a structural attachment, such as the door handle, the lock or the window lift rails, which must be attached directly to the door to which the loads are transmitted.

A special element is the door insert. If the sealing element remains attached to the trim at all times, it will remains disassembled during the entire mounting process, albeit temporarily pre-mounted, as it is the last part attached to the panel. The insert covers an opening in the panel that allows the final assembly of the door window and other accessories located in the dry area of the vehicle. The insert is joined to the trim panel at the end of the mounting operations by elements that can belong to the insert itself or be external to it. However, when the sealing element is attached to the trim only until the time of installation, the insert does not have to be removed as the trim does not prevent the installation in the dry area of the various components, and specifically of the sealing element.

It is necessary that the trim panel and the elements that it incorporates can be mounted easily and quickly. For this reason, the trim panel and the door box have openings that simplify these mounting operations and provide access to the wet area from the dry area.

To execute the mounting, the components located in the wet area of the vehicle must be mounted first. To access this area the innermost plate of the door box has at least one main opening that provides access to the wet area from the dry area.

After this the innermost plate is sealed with the corresponding sealing elements and the components located in the dry area are mounted; or, as the trim has not been incorporated yet in the first case in which a temporary attachment is established, or in the rest of cases through the opening made in the trim panel with the insert removed. In the latter cases the insert is mounted after the panel.

Mounting of the various elements is also made possible by several auxiliary orifices and attachment elements provided with self-centering means that are provided in the trim panel and the door box.

Also considered part of the present invention is the procedure for mounting the module, which will be described in detail further below.

Lastly, the sealing element allows integrating other additional components, such as an energy-absorbing element in case of lateral impacts, the lock support, the window pane guide, attachment brackets, etc. It can also perform other additional functions such as protection against undesired access to the lock from the outside, such as by including a security ribbing.

### DESCRIPTION OF THE DRAWINGS

The present descriptive memory is accompanied by a set of drawings that illustrate the preferred example without limiting it in any way.

FIG. 1 shows on the top an elevation view of an embodiment of the trim panel on the side facing the vehicle interior and on the bottom an elevation view of the rear face of the trim panel in the case that the panel incorporates a single sealing element.

FIG. 2 shows the plate of the door box seen from the dry area with a single main opening for access to the wet area of the door box.

FIG. 3 shows the trim panel as seen from the dry area without the insert, leaving an opening through which some of the elements incorporated in the panel can be seen.

FIG. 4 shows a representation of the sealing element with a lock. On the bottom left is an embodiment of a form of attachment to the door plate with a tab and on the bottom right is an enlarged view of this form of attachment with the sealing element.

FIG. 5 shows a cross section of the assembly of the bottom edge of the sealing element on the door box plate and an enlarged view of the compressed sealing element.

FIG. 6 shows a cross section of the door box plate and the sealing element in an initial position, before placing the sealing element on the corresponding main opening of the door box plate, and in a final position in which the sealing element covers the main opening.

FIG. 7 shows an embodiment of the temporary attachment elements of the sealing element to the trim panel and an enlargement showing the possible relative movements between them.

FIG. 8 shows an embodiment of the invention in which the sealing element has a temporary dependence on the rim panel, so that during the mounting process it is possible to separate them. The representation on the left corresponds to a view from outside the vehicle and the representation on the right corresponds to a view from inside the vehicle.

FIG. 9 shows an enlarged view of the subassembly of the same embodiment in which the lock support and a segment of the window guide are shown joined to the sealing element.

FIG. 10 shows a complete view of the same sealing element in which certain details are shown such as the integration of the absorbing element in case of impact.

FIG. 11 shows a last view of the same sealing element with the temporary attachment means to the trim when the latter has a supporting function.

FIG. 12 shows an enlarged view of a grommet type connection for anchoring the wire harness to the vehicle.

### DETAILED DESCRIPTION OF SEVERAL PREFERRED EMBODIMENTS

The present invention consists of a supporting module for vehicle doors, intended for installation on doors of motor vehicles.

It consists of a trim panel (2) that acts as a non-structural supporting element, incorporating several functional components of the door, to facilitate its handling and transport to its final working position. This panel (2) is free of any structural responsibility and does not provide the sealing. The sealing is provided by incorporating a component, hereinafter referred to as the sealing element (3), which is described further below.

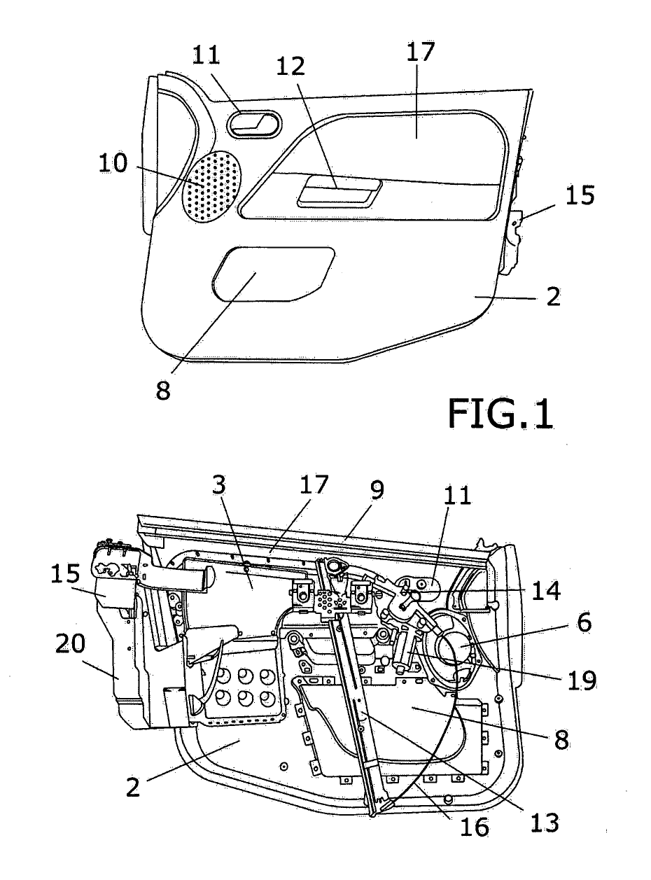

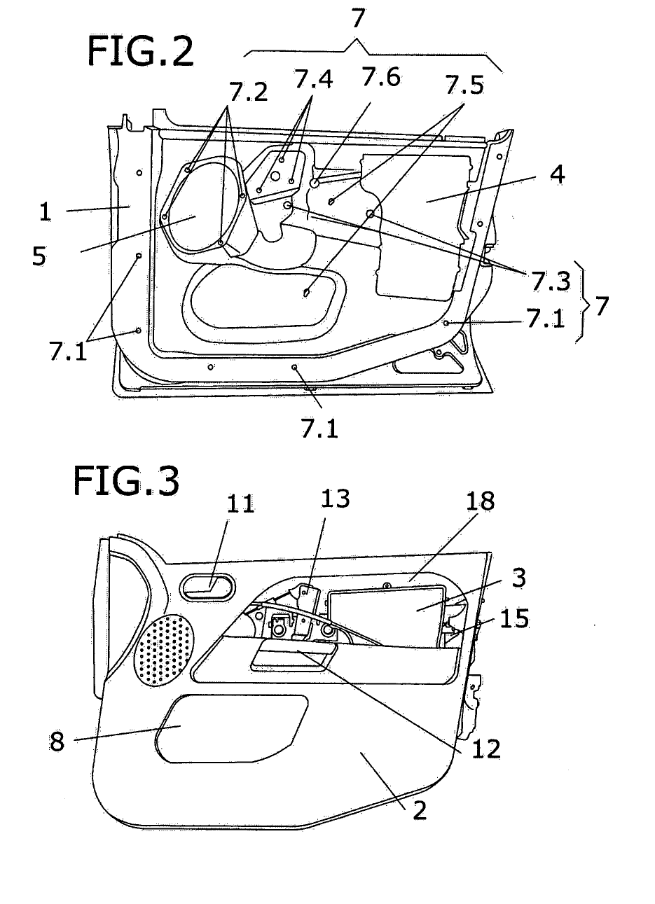

The function of the trim panel (2) as a supporting module simplifies the handling and mounting operations of the various functional components of the door. In order to allow mounting these components, as well as their independent removal, the inner plate (1) of the door box has at least one main opening (4) and an additional opening (5) to house the speaker (6), as shown in FIGS. 1 and 2, as well as the secondary orifices (7) needed to mount or regulate said components.

The door box (1) can have more than one main opening (4), each one closed with a sealing by the corresponding sealing element (3). The examples shown correspond to the case of a single main opening (4) and therefore to a panel (2) incorporating a single sealing element (3).

Hereinafter we will refer only to the case of one main opening (4) and one sealing element (3), considering however at all times that there may be more than one opening (4) and thus more than one sealing element (3).

As regards the aforementioned secondary orifices (7), this denomination extends to different minor openings, shown in FIG. 2, which to complete the description are now described briefly.

The door box plate has openings (7.1) located peripherally on the bottom and right and left sides, meant to anchor the trim panel (2). The attachment is effected in this case by clipping the panel (2) and the plate (1) of the door box, the clip itself providing the sealing.

To anchor the speaker (6) to the plate (1) of the door box, the speaker opening (5) is provided on its perimeter with the corresponding minor openings (7.2) for screwing the speaker (6) onto the plate (1). In this case the screws also provide the sealing. In another example of embodiment the speaker (6) can be screwed on the trim panel (2), and thus does not have to be screwed afterwards on the door plate (1).

Other openings provided are the openings (7.3) intended to house the body of the door handle (12) and the openings (7.4) that allow anchoring the window lift motor (19). In this case, the attachment and the sealing are also ensured by the attachment screws.

The openings (7.5) that allow attaching the window lift rail or rails (13) are covered by corresponding plugs that ensure a sealing.

Another opening (7.6) is required to regulate the window anchoring, which is also covered by the corresponding sealing plug.

As mentioned above, one can distinguish in the door a dry area with the same conditions as the vehicle interior and a wet area that is exposed to the entry of dust and water from the outside. Any components located in the wet area require a suitable protection. In any case, the two areas must be separated by a sealing.

In the present invention the separation of the dry area and the wet area is established by the inner plate (1) of the door box, while the sealing is established by the sealing element (3) that covers the main opening (4) of said plate (1). The sealing element (3) is also incorporated in the pre-mounted trim panel (2) that is supported by a temporary attachment; subsequently, several final operations establish the final mounting on the doorplate (1). Although a first embodiment of the invention is described using temporary means, other temporary means will be described further below that only fulfil their function attaching the sealing element (3) to the trim panel (2) until the time of installation.

As shown also in FIG. 2, the inner plate is also provided with the main opening (4) (which provides access to the wet area), with another opening (5) that is the housing of the speaker (6) and other secondary orifices (7) that are adequately sealed to ensure a full seal between the wet and dry areas, as mentioned above.

FIG. 1 shows an elevation view of the trim panel (2) with several components incorporated. The top part of the figure shows the side facing the vehicle interior. The bottom part of the figure shows the opposite side, which faces the dry area of the door box.

The trim panel (2) acts as a supporting element in which some elements are fixed, this is, in their working position, while others are pre-mounted and require an additional operation to fix them in their final working position and others have a temporary attachment, i.e. they are incorporated to the panel (2) to facilitate its handling and mounting but are fixed in different positions, as described below.

In this preferred embodiment shown in FIG. 1, the base of the pocket (8), the weather strip (9) and the clips (not shown) for attaching the panel (2) to the door, are components that are attached permanently to the trim panel (2).

In this example, the base (8) of the pocket is mounted permanently on the panel (2) and the front of the pocket is part of the panel. In other embodiments the opposite may be true, so that the front of the pocket is mounted permanently on the panel and the base (8) that forms part of it.

Also in the example shown in FIG. 1, the grille (10) of the speaker (6) is also fixed to the panel (2), although in other embodiments it may be a part (10) independent of the panel (2) that is attached later, although it may be pre-mounted on the panel (2) to facilitate the manipulation of the assembly.

Other components are already mounted in their working position in the trim panel (2), such as the wire harness and the inner actuation (11) of the door.

The body of the handle (12) and the speaker (6) are instead pre-mounted on the trim panel (2) for its handling and transport to the door (1), where they require final operations to fix them in their working position.

The trim panel (2) also incorporates elements which, as said panel (2) is a supporting element, are only pre-mounted on it to facilitate their handling, but which must be fixed to the door (1) later. This is the case of the lock (15) and its case (20), and the window lift assembly consisting of the window lift rail or rails (13), the motor (19), a reducer, the transmission means (16), the drum lid (14) and the means for redirecting the transmission means.

FIG. 1 also shows the insert (17) and the sealing element (3).

The insert (17) remains disassembled while the components are mounted on the door (1), as it reveals an opening (18) in the trim panel (2) required to mount the window glass and other accessories on the door, as will be described later. Therefore, the insert (17) is a disassembled part that is joined to the trim panel (2) in a temporary manner.

The sealing element (3) is another element pre-mounted on the panel (2) that is not definitively attached to the door (1) until one of the final mounting operations after positioning the module, as the opening (4) that it covers in the door box plate (1) provides access to the wet area of the box for mounting the components located in this area.

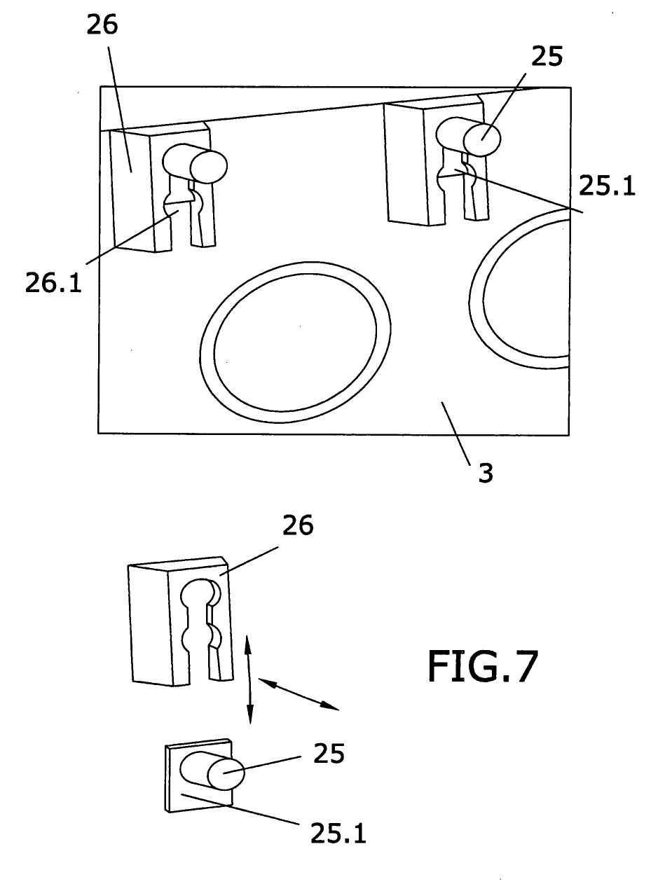

FIG. 7 shows an embodiment of the means for temporary attachment of the sealing element (3) to the trim panel (2).

FIG. 7 shows pivots (25) corresponding to the trim panel (2) (the panel (2) is not shown in the figure), which end at a retaining heads (25.1). The pivots (25) are inserted in boxes (26) that emerge from the face of the sealing element (3) facing the dry area.

The boxes (26) have slits (26.1) that allow a vertical movement of the picot (25) in the box (26). Horizontal movement perpendicular to the trim panel (2) is also possible; the retaining heads (25.1) prevents the pivots (25) from leaving the boxes (26) of the sealing element (3). The bottom part of FIG. 7 shows said vertical and horizontal movements by arrows.

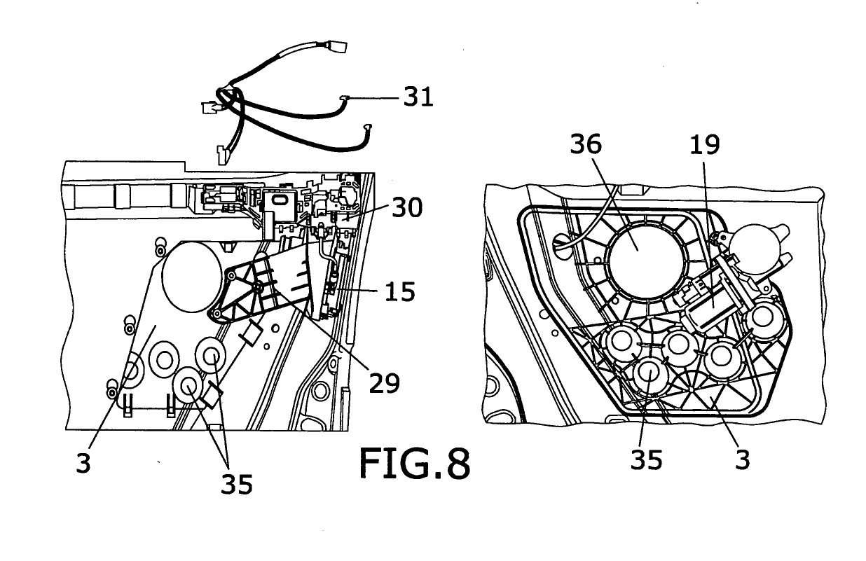

FIGS. 8, 9, 10 and 11 show another embodiment of the invention in which the sealing element (3) is connected to the trim panel (2) in a temporary manner, only when the panel (2) has a supporting function.

The attachment of the sealing element (3) and the trim panel (2) is established by clips (33, 34). This example uses male clips (33) at the peripheral points and one female clip (34) at a point coincident with a turret of the impact absorption element, as it is raised from the main surface of the sealing element (3).

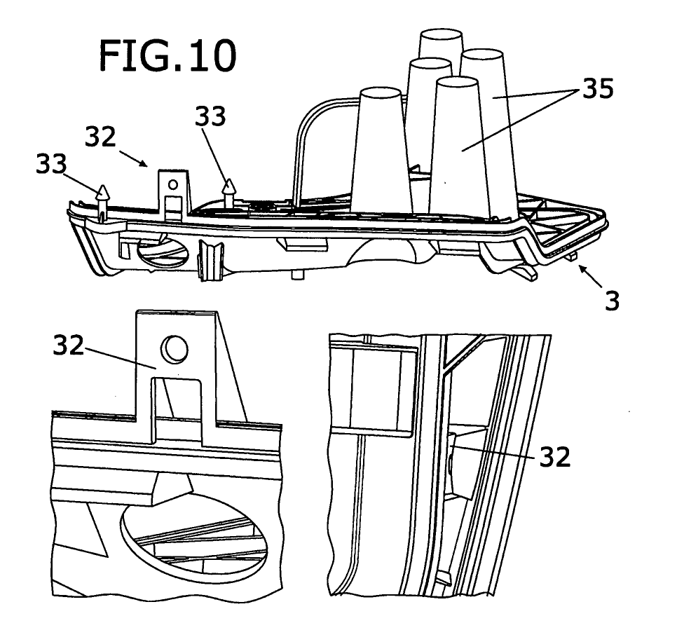

FIG. 10 also shows a bracket (32) that allows to rejoin the sealing element (3) to the trim panel (2) at the final position.

In this same case, at the time of installation the sealing element (3) is separated from the trim panel (2). This separation allows to leave the trim panel (2) aside, simplifying the manipulation of the sealing element (3) with the elements joined to it: the lock support (29) and a segment (29.1) of the window guide that is integrated in the support (29).

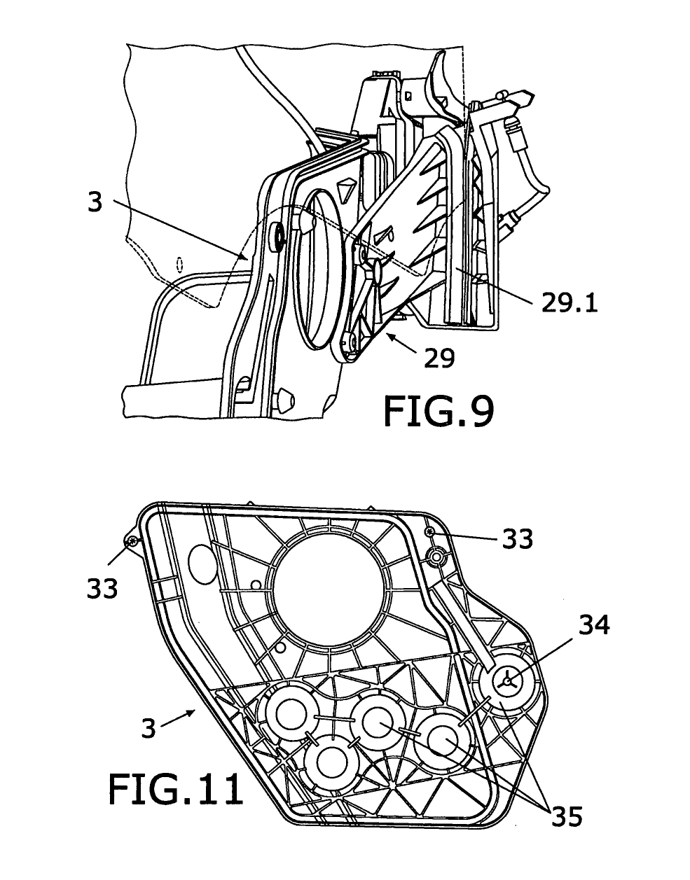

The latter details are shown in FIGS. 8 and 9. FIG. 8 also shows the external opening module (30) that is placed on the lock support (29) and also shows separately the wire harness (31).

The lock (15) is located at the end of the lock support (29), coinciding with the edge of the door, where it is permanently attached.

In this example of an embodiment the impact absorption element (35) or padding has been integrated, the window guide (29.1), its rubber, the wire harness (31) and the lock (15) are mounted: the external opening module (30) and the window lift motor (19) are pre-mounted.

It is also possible for the sealing element (3), as in other embodiments of the invention, to be provided with a security ribbing that prevents access to the window supports so that it cannot be broken.

It should be remarked that in this embodiment it is not necessary for the insert (17) to allow access to the inside of the door box, so that it may be fixed from the start on the trim panel (2).

Described next is the mounting procedure for the various functional elements of the door shown in FIG. 1, from the trim panel (2) to its final working position on the door (1).

Starting with the trim panel (2) as a supporting element with the aforementioned elements incorporated, shown in FIG. 1, the mounting operations for the functional component and trim panel (2) on the door are the following:
1. Placing the trim panel (2) next to the door;
2. Disengaging the window lift assembly and positioning it in the wet area of the door box;
3. To execute this positioning and attachment the wet area is accessed through the main opening (4) provided in the inner plate (1) of the door box which remains open. If the window lift configuration allows, the window lift assembly can be mounted between the outer and inner skin of the door plate box, on the window hugger side. In addition, there is no other element covering the front part of the box plate (1), so that the operator can see the various orifices (7) required to attach the aforementioned components;
4. Attaching the window lift motor (19) in the dry area of the door (1) and connecting it to the drive chain (16) with the corresponding wire harness. In this operation the worker passes the window lift assembly through the main opening (4) and, with the motor (19) in view, attaches it through the corresponding openings (7.4) to then attach the drum lid (14). Bolting is only required at this time when the connection between the sealing element (3) and the trim panel (2) is temporary with attachment during the installation, as the trim panel (2) covers it and would not allow bolting afterwards;
5. Passing the lock (15) through the main opening (4) that provides access to the wet area;
6. Connecting the electrical and mechanical terminals to the components mounted on the trim panel (2);
7. Mounting the trim panel (2) on the door (1). When the trim panel (2) remains attached to the sealing element (3) during installation, the panel (2) will have the insert (17) removed to reveal the opening (18) that houses it, in order to continue with the following mounting operations. In this case the sealing element (3) is pre-positioned on the panel (2);
8. Mounting the window glass. When the trim panel (2) remains attached to the sealing element (3) during installation, the assembly is performed by accessing through the space (18) left open by the insert (17). The glass is placed on and attached to the carriages of the window lift guides (13);
9. Attaching the sealing element (3) on the door (1), covering the main opening (4) providing access to the door box through the space (18) left open by the insert (17) when this is the case, as described later in greater detail;
10. Sealing the secondary orifices (7), accessing through the insert space (18);
11. When there is a temporary attachment of the trim panel (2) remains to the sealing element (3), mounting the insert (17) on the panel (2). In this embodiment the insert (17) is attached by clipping. Other modes of attachment are also possible;
12. Screwing the body of the handle (12) onto the door (1).

The speaker (6) may be mounted in two ways: bolted on the trim panel (2) in which case it would not require any operation, or pre-mounted on the trim panel (2) so that it must be bolted to the door plate (1).

In this case, when the speaker is pre-mounted on the trim panel (2) and when the attachment of the sealing element (3) and the trim panel (2) is temporary until installation, the speaker (6) is bolted on after attaching the window lift motor (19) in a phase in which several elements are bolted on. When the speaker (6) is pre-mounted on the trim panel (2) but the attachment between the sealing element (3) and the trim panel (2) is temporary during the installation and also permanent, the speaker (6) is attached after positioning the motor (19) and before placing the module of the door panel (2).

The mounting operations described above can be complemented by the following for greater detail.

The lock (15) and lock case (20) are joined to the sealing element (3) in any mode of attachment and the assembly is pre-positioned in the trim panel (2) when their attachment is maintained until the end. Therefore, when the lock (15) is mounted, the lock (15), its case (20) and the sealing element (3) are positioned in a single operation.

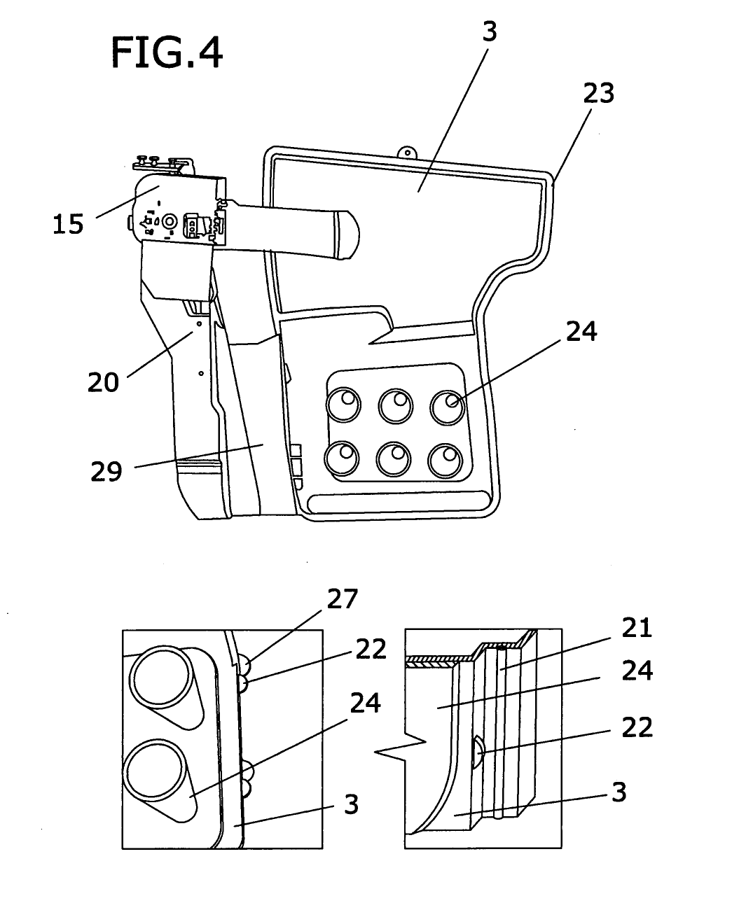

FIG. 4 shows the sealing element (3) and its elements (22) for attachment to the door (1) in one example of embodiment.

The sealing element (3), as mentioned above, is the element that closes the main opening (4) of the inner plate (1) of the door box and which provides access to the wet area. This element (3) provides a sealing between the dry area and the wet area.

Said element (3) is made of plastic and adapted to the shape of the main opening (4) of the door box. In addition, to ensure the sealing the element (3) is also provided with a peripheral elastic sealing gasket (21) and protrusions (22) that maintain the element (3) in its working position, ensuring its correct operation as they allow attaching the sealing element (3) to the door box (1).

As shown in FIG. 4, the sealing element (3) has tabs (22) on the perimeter of the side facing the wet area of the box. On the perimeter of the element (3), opposite the tabs (22), the sealing element (3) is provided with a lip (23) that houses the sealing gasket (21). Thus, between the peripheral lip (23) and the tabs (22) is a space approximately equal to the thickness of the plate (1) of the door in which it is mounted, plus a space filled by the sealing gasket (21) so that a pressure makes the gasket (21) give until the tabs (22) of the sealing element (3) can reach beyond the inner supporting plane.

The sealing element (3) is pre-mounted on the trim panel (2) with a temporary attachment that connects them. When this connection is maintained at all times a certain relative movement is allowed between the parts (2) and (3), as mentioned before. When the temporary connection is only maintained during transport, the trim panel (2) no longer hinders the manipulation of the sealing element (3). Its final mounting is performed by the following steps.

First the sealing element (3) is positioned resting its peripheral edge (23) on the main opening (4) of the box, on its dry area, slightly displaced from its final position. The position is such that the peripheral gasket (21) rests on the plate (1) and the tabs (22) are opposite incuts (27) made in the plate (1) for this purpose. In this position, by exerting a pressure to overcome the resistance of the compression of the sealing gasket (21) the tabs (22) can overcome the incuts (27).

Then the sealing element (3) is made to slide in a vertical downwards sense to its final position, so that all the tabs (22) rest on the side of the plate opposite that in which the sealing element (3) rests, as it is not opposite the incuts (27).

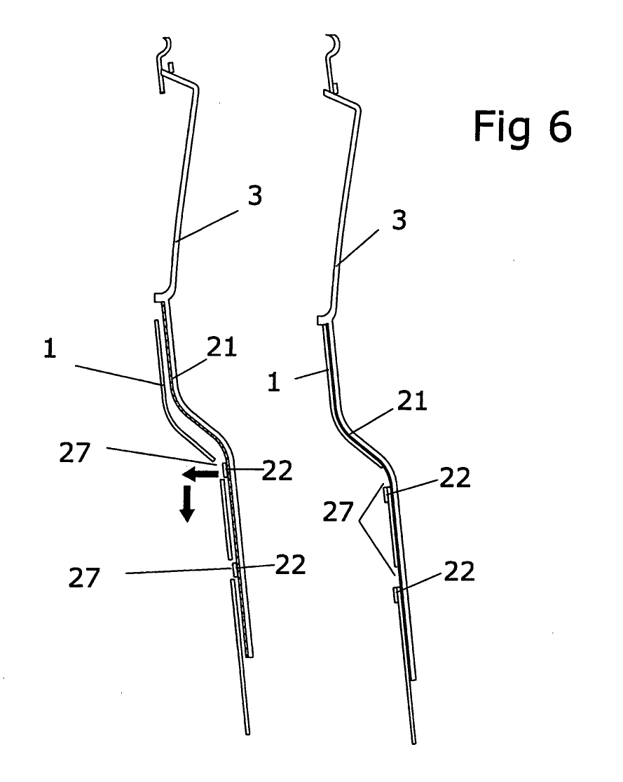

FIG. 6 shows a cross section of the sealing element (3) and the door box plate (1).

In the drawing on the left of FIG. 6 the sealing element (3) is pre-positioned with respect to the main opening (4) such that the tabs (22) are opposite the incuts (27) made in the door box plate (1). Two arrows indicate the above-described movements of the sealing element (3) to reach their final position from this starting position.

The drawing on the right of FIG. 6 shows the sealing element (3) already in its final position. The tabs (22) are shown resting on the face of the plate (1) opposite that on which the sealing element (3) rests.

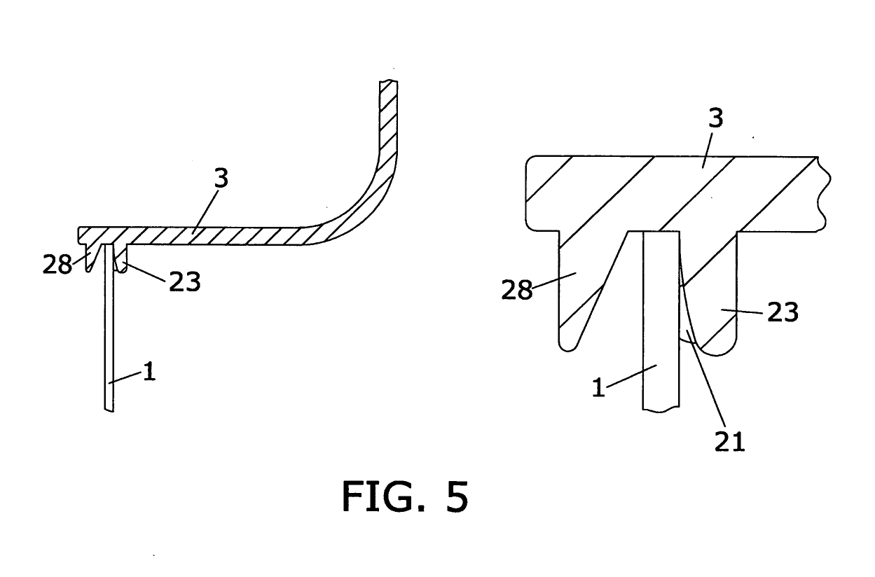

FIG. 5 shows the attachment of the bottom edge of the sealing element (3) to the door box plate (1). The bottom edge has a second lip (28) such that the section of the edge has a wedged “V” shape. The sealing gasket (21) in the bottom part of the sealing element (3) is placed between the two lips: the peripheral lip (23) surrounding the entire element (3) and the second bottom lip (28).

When the sealing element (3) is lowered the wedge action is favoured, placing the plate (1) between the two lips (23, 28) and pressing the sealing gasket (21) as shown in the enlargement of FIG. 5.

Lastly, the attachment of the sealing element (3) is strengthened by an additional attachment element such as a screw or a rivet.

Other means for attaching the element (3) to the plate (1) are also possible. For example, by pairs of tabs. This is, each tab (22) is accompanied by an additional tab to form pairs, so that once mounted on the plate (1) of the door box it will be embraced by each pair of said tabs (22), one tab of each pair on either side of the plate.

Another possibility is to attach the sealing element (3) to the panel (2) using permanent attachment means, which do not allow the relative displacement between them, such as screws. Thus, when the sealing element (3) is displaced to attach it to the door box (1), the element (3) moves together with the panel (2).

In addition, the element (3) providing the sealing can perform additional functions. Thus, it can incorporate energy absorption elements in case of impact, such as deformable cones (24).

Another function that can be integrated in the sealing element (3) is protection against undesired access from outside the vehicle to the lock (15). For this purpose, a skirt can be included to protect sensitive parts against undesired opening.

Alternatively, in another example of embodiment in which there are no additional parts for providing the seal and in which there is no previous attachment of the trim and the sealing element but there is a temporary attachment until installation, three sub-assemblies can be differentiated:
window lift assembly without a motor;
the door trim;
the sealing element (3) which supports the lock support (29), the lock (15), the external opening lever (30), the window lift motor (19) and the wire harness (31), all of this as shown in FIG. 8.

FIG. 9 shows how the sealing element (3) in addition to carrying out the sealing and impact-resistance functions acts as a union to the lock through the lock support (29), the support (29) having a groove (29.1) to guide the window pane.

In addition and in order to provide added security to the lock and inner opening lever, the sealing element is provided with a security ribbing on the face visible from the inside.

To allow attaching the sealing element to the trim once the attachment element is housed in the plate orifice, which if possible will be the only orifice, attachment means are provided on the sealing element which in the case shown in FIG. 10 will be a bracket (32).

Although it is not intended at this time to fully incorporate the sealing element on the trim, during the transport of the set of parts required for the mounting process and in order to keep the sealing element joined to the trim, provided on the sealing element (3) are a number of male clips (33) and a truncoconical shaped protrusion that acts as a female clip (34), as shown in FIG. 11.

For the sake of clarity, the stages involved in the mounting of the trim panel (2) as a module according to the configuration of this option are listed below.
1. Placing the trim panel (2) next to the door;
2. Disengaging the window lift assembly and positioning it in the wet area of the door box (1);
3. Positioning and attaching the window lift assembly;
4. Positioning the window lift motor (19) and attaching it by clipping;
5. Positioning the sealing element (3);
6. Positioning and attaching the external opening lever by clips on the outer plate of the door box through the orifice (36) of the sealing element (3);
7. Placing the window pane in place;
8. Screwing on all the remaining elements: speaker (if applicable), motor (19), sealing element (3), lock (15), joining the window lift to the window;
9. Sealing the secondary orifices (7);
10. Mounting the trim panel (2) which in this case includes the insert (17);
11. Screwing on the handle and inner opening lever.

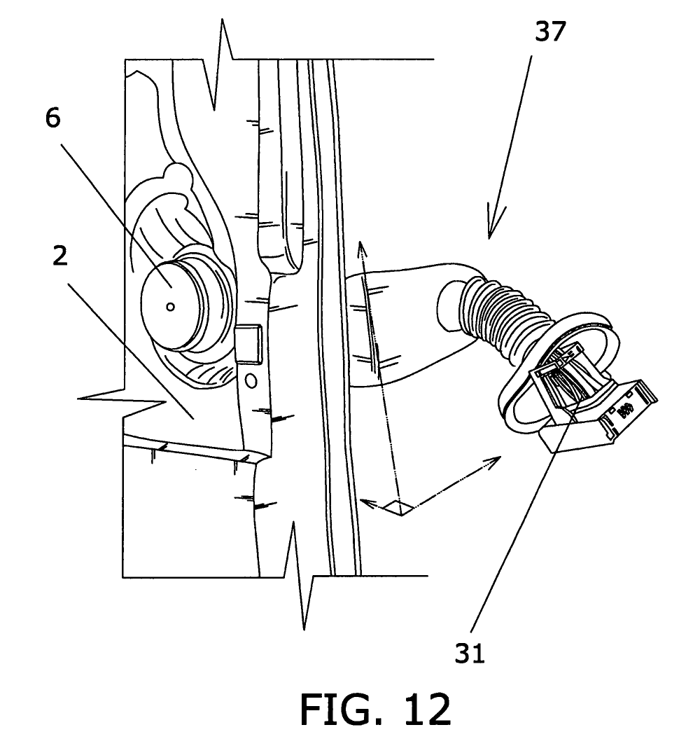

FIG. 12 shows a detail that can be applied to any embodiment described for the invention, in which a grommet type connection (37) is used to anchor the cables or wire harness (31) to the vehicle's wire harness. The grommet type connection (37) described as a form of embodiment is configured in an L-shape on the hinged side of the door, extending as a bellows to allow the flexion required when opening and closing the door.

Although connections of this type are known, it is considered to be applicable to this invention regarding the installation procedure as the grommet type connection can be either mounted or integrated in the injection of the door panel (2), so that a mounting operation is avoided, this mounting operation being included in the mounting of the modular door panel.

The essence of the invention is not affected by variations in the materials, shape, size and arrangement of the component elements, described in a non-limiting manner such that it allows its reproduction by an expert.

1. Supporting module for vehicle doors constructed as a non-structural panel, meant to act as a trim on doors having a box with at least one main opening to allow manual access by an operator for mounting, essentially, the components installed in the wet area, the box being able to have other openings and orifices not intended for manual access by the operator, such as the speaker housing or auxiliary orifices for allowing tools to pass, characterised in that the trim panel (2) incorporates, on each main mounting opening (4) provided in the inner plate (1) of the door box, a sealing element (3) meant to cover it in order to provide a sealing between the dry area and the wet area of the door; wherein the trim panel (2) could be also provided with an access opening (18) for completing the final mounting operations of the elements located in the dry area and the additional sealing element (3).

2. Supporting module for vehicle doors according to claim 1, characterised in that the trim panel (2) incorporates a single sealing element (3) meant to cover a single main mounting opening (4) present in the inner plate of the door box (1).

3. Supporting module for vehicle doors according to claim 1, characterised in that between the module (2) and the sealing element (3) are established temporary mutual attachment means.

4. Supporting module for vehicle doors according to claim 3, characterised in that between the module (2) and the sealing element (3) the temporary mutual attachment means are established during the supporting function of the trim panel (2).

5. Supporting module for vehicle doors according to claim 4, characterised in that the sealing element (3) is provided with means for attachment during transport.

6. Supporting module for vehicle doors according to claim 5, characterised in that the means for attachment during transport of the sealing element (3) are a number of clips (33) and at least one protrusion with a truncoconical shape that presents a female clip (34) that allow to maintain the sealing element (3) next to the trim during transport.

7. Supporting module for vehicle doors according to claim 1, characterised in that the sealing element incorporates a padding.

8. Supporting module for vehicle doors according to claim 1, characterised in that the sealing element incorporates the support (29) of the lock (15).

9. Supporting module for vehicle doors according to claim 8, characterised in that the support (29) of the lock (15) is integrated in the sealing element (3).

10. Supporting module for vehicle doors according to claim 1, characterised in that the support (29) of the lock (15) has a groove (29.1) that acts as a guide for the window.

11. Supporting module for vehicle doors according to claim 1, characterised in that the sealing element (3) is provided with a security ribbing on the face visible from the inside to prevent any manipulation of the lock-inner opening handle.

12. Supporting module for vehicle doors according to claim 1, characterised in that on the sealing element (3) is a bracket for a temporary union to the trim panel (2).

13. Supporting module for vehicle doors according to claim 1, characterised in that the sealing element (3) acts as a means for attaching the window lift motor (19) during transport.

14. Supporting module for vehicle doors according to claim 1, characterised in that the sealing element (3) acts as a means for attaching the wire harness during transport.

15. Supporting module for vehicle doors according to claim 1, characterised in that, between the module (2) and the sealing element (3), the mutual attachment means (25, 26) allow a relative motion or play of the two parts (2, 3) to allow the attachment operation of the sealing element in the main opening (4) of the inner door plate (1).

16. Supporting module for vehicle doors according to claim 15, characterised in that the access opening (18) for completing the mounting operations is covered by an insert (17).

17. Supporting module for vehicle doors according to claim 16, characterised in that the insert (17) is attached to the trim panel (2) by clips.

18. Supporting module for vehicle doors according to claim 1, characterised in that the temporary attachment means (25, 26) consist of pivots (25) that emerge from the trim panel (2) and end at a retaining head (25.1), which fit in slits (26.1) made in boxes (26) attached to the sealing element that allow a relative vertical movement and a horizontal movement perpendicular to the trim panel (2) between the sealing element (3) and the trim panel (2).

19. Supporting module for vehicle doors according to claim 1, characterised in that the attachment between the module (2) and the sealing element (3) is performed by permanent attachment means.

20. Supporting module for vehicle doors according to claim 1, characterised in that on the trim panel (2) a pocket base (8) is mounted permanently on the panel and a pocket front forms part of this panel to configure a pocket for containing objects.

21. Supporting module for vehicle doors according to claim 1, characterised in that a pocket front is mounted permanently on the panel and a pocket base is part of the panel to configure the pocket for containing objects.

22. Supporting module for vehicle doors according to claim 1, characterised in that the trim panel (2) incorporates a lock (15) and its case (20), which are joined to the sealing element (3) and pre-positioned on the panel (2).

23. Supporting module for vehicle doors according to claim 1, characterised in that the trim panel (2) incorporates at least one window lift rail (13), as well as a reducer motor (19), transmission means (16), a drum lid (14) and means for redirecting the transmission means.

24. Supporting module for vehicle doors according to claim 23, characterised in that the trim panel (2) incorporates one single window lift rail (13), one reducer motor (19), transmission means (16), one drum lid (14) and means for redirecting the transmission means.

25. Supporting module for vehicle doors according to claim 1, characterised in that the trim panel (2) incorporates a grille (10) for the speaker (6).

26. Supporting module for vehicle doors according to claim 1, characterised in that the sealing element (3) has a peripheral sealing gasket (21).

27. Supporting module for vehicle doors according to claim 1, characterised in that the means for attaching the sealing element (3) to the plate (1) of the door box are peripheral tabs (22).

28. Supporting module for vehicle doors according to claim 1, characterised in that the means for attaching the sealing element (3) to the plate (1) of the door box are pairs of peripheral tabs (22).

29. Supporting module for vehicle doors according to claim 1, characterised in that the upper attachment of the sealing element (3) to the plate (1) of the door box is achieved by screws.

30. Supporting module for vehicle doors according to claim 1, characterised in that the lower edge of the sealing element (3) is provided with a second lip (28) such that the section of the edge has a wedge-like “V” shape.

31. Supporting module for vehicle doors according to claim 1, characterised in that the door box (1) is provided with secondary orifices (7) for mounting and regulating the functional components of the door.

32. Supporting module for vehicle doors according to claim 31, characterised in that the secondary orifices (7) are sealed by sealing elements or gaskets to provide a sealing between the wet area and the dry area.

33. Mounting procedure of the supporting module for vehicle doors as claimed in previous claims, characterised in that the mounting procedure is performed by a sequence of operations that includes at least the following stages:
Placing the trim panel (2) next to the door;
Disengaging the window lift assembly and placing it in the wet area of the door box, wherein this positioning and attachment is performed by accessing the wet area through the main opening(s) (4) established in the inner plate (1) of the door box that is/are still open;
Attaching the window lift motor (19) and connecting it to the drive train (16);
Incorporating and attaching the sealing element (3);
Screwing the body of the handle (12) and the inner opening lever on the door (1).

34. Mounting procedure of the supporting module for vehicle doors according to claim 33, characterised in that the stages make use of a sealing element (3) that has a temporary attachment during the installation of the trim panel (2).

35. Mounting procedure of the supporting module for vehicle doors according to claim 34, characterised in that the motor (19) is attached by screws.

36. Mounting procedure of the supporting module for vehicle doors according to claim 34, characterised in that the mounting of the sealing element (3) requires a previous stage in which the lock (15) is passed through the main opening (4) that provides access to the wet area, followed by the mounting of the panel (2) itself on the door (1), the insert (17) remaining separate from the trim panel (2).

37. Mounting procedure of the supporting module for vehicle doors according to claim 34, characterised in that the mounting of the sealing element (3) requires the previous mounting of the window through the space (18) left open by the insert (17), placing and attaching the window to the carriages of the window lift guides (13).

38. Mounting procedure of the supporting module for vehicle doors according to claim 34, characterised in that the attachment of the sealing element (3) is performed through the space (18) left open by the insert (17) by a frontal displacement manoeuvre with a pressure exerted by the sealing element (3) plus a transverse displacement for a first attachment by tabs (22), finally screwing it onto the door box (1).

39. Mounting procedure of the supporting module for vehicle doors according to claim 34, characterised in that after the sealing element (3) has been attached the secondary orifices (3) are sealed and the insert (17) is attached.

40. Mounting procedure of the supporting module for vehicle doors according to claim 33, characterised in that the stages make use of a sealing element (3) that has a temporarily attachment until the installation to the trim panel (2).

41. Mounting procedure of the supporting module for vehicle doors according to claim 40, characterised in that the motor (19) is attached by clips.

42. Mounting procedure of the supporting module for vehicle doors according to claim 40, characterised in that the attachment of the sealing element (3) first requires to pass the lock (15) through the main opening (4) for access to the wet area.

43. Mounting procedure of the supporting module for vehicle doors according to claim 40, characterised in that the sealing element (3) is attached by clips.

44. Mounting procedure of the supporting module for vehicle doors according to claim 40, characterised in that after the sealing element is attached by clips the external opening lever is positioned and attached by clips on the outer plate of the door box, through the orifice (36) of the sealing element (3).

45. Mounting procedure of the supporting module for vehicle doors according to claim 40, characterised in that after the external opening lever is positioned and attached by clips the window is placed.

46. Mounting procedure of the supporting module for vehicle doors according to claim 40, characterised in that after the window is placed all remaining elements are screwed on, such as the speaker (6) if applicable, the window lift motor (19), the lock (15), and the window lift is connected to the window.

47. Mounting procedure of the supporting module for vehicle doors according to claim 40, characterised in that the sealing element is attached by screws.

48. Mounting procedure of the supporting module for vehicle doors according to claim 40, characterised in that after the sealing element (3) is attached the secondary orifices (7) are sealed.

49. Mounting procedure of the supporting module for vehicle doors according to claim 40, characterised in that after the sealing element (3) is attached the trim panel (2) is mounted on the door, wherein it is possible to further attach the sealing element (3) and the trim panel (2) by a screw-on bracket (32).

50. Mounting procedure of the supporting module for vehicle doors according to claim 1, characterised in that the wire harness (31) of the door is connected to the wire harness of the vehicle by a grommet type connection (37), mounted or integrates in such a manner that the mounting of this connection forms part of the mounting operations of the door panel (2).
